(19) United States
(12) Patent Application Publication
(10) Pub. No.: US 2019/0031560 A1
(43) Pub. Date: Jan. 31, 2019

(54) METHOD OF PRODUCING ANTI-GLARE GLASS AND PRODUCT THEREOF

(71) Applicant: 3MACJET TECHNOLOGY CO., LTD., TAINAN CITY (TW)

(72) Inventors: YUNG-HSIEN LU, TAINAN CITY (TW); RUEI-MING HUANG, TAINAN CITY (TW)

(21) Appl. No.: 15/708,532

(22) Filed: Sep. 19, 2017

(30) Foreign Application Priority Data
Jul. 25, 2017 (TW) 106124870

(51) Int. Cl. C03C 17/00; C03C 17/25

(52) U.S. Cl. CPC C03C 17/007; C03C 17/25; C03C 2217/445; C03C 2218/119; C03C 2217/48; C03C 2217/72; C03C 2217/475

(57) ABSTRACT

An anti-glare glass forming method and a product thereof is provided. A matte ink is sprayed on a glass by an inkjet printer and then dried by a heating device to form a matte layer. Thereby, an injection amount, patterns, and printing density can be precisely controlled to let the glass substrate to have anti-glare effect or have a matte layer with various haze.

### BACKGROUND

### Field of Invention

The disclosure relates to a forming method of an anti-glare glass and a product thereof. More particularly, the disclosure relates to a method of conveniently forming a matte layer with anti-glare effect and various haze on a glass substrate by an inkjet process.

### Description of Related Art

The existing matte processing methods mainly include sandblasting, chemical etching, and spraying by spray guns. The sandblasting sprays emery onto the glass surface to produce impact by high-pressure air through the blasting gun, such that many granular depressions are formed on the glass surface to produce matte effect. However, the way of impacting the glass surface by the emery will decrease the strength of the glass, and thus the fragmentation is easily produced at the matte parts of the glass. At the parts of no sandblasting, a protection film has to be attached on the glass surface before the sandblasting, so that no matte surface will be produced at the parts shielded by the protection film. Therefore, the sandblasting processing method is very time consuming and labor consuming. Moreover, the amount, strength and range of spraying emery by the high-pressure air cannot be precisely controlled, and the quality of the matte surface of the glass is also decreased.

In the method of forming matte glass by chemical etching, HF is mainly used to cover the glass surface to etch the glass surface, so that the glass surface is rugged. However, HF is a highly toxic liquid with strong corrosive and volatile property. Hence, it is easy to cause environmental pollution. Moreover, if attention is not paid in the etching process, the glass is very vulnerable to be damaged by the corrosion of the toxic chemical to cause harm to the human body. In addition, the chemical etching process is quite complex and time consuming. It is not easy to control the corrosion degree. The strength of the glass will be decreased at the portions etched by the chemical. Therefore, the glass can be easily fragmented in the use.

In the spraying method using spray guns, coatings are sprayed on to the glass surface by spray guns using high-pressure air, and the glass surface is rugged by the coating. Before spraying, a protection film also needs to be attached on the parts of no spraying. Since the coating is sprayed by using high-pressure air, the amount, strength and range of the spraying cannot be precisely controlled to decrease the quality of the matte surface of the glass. Furthermore, since all of the sandblasting, chemical etching, and spraying by spray guns cannot precisely control the haze of the matte surface of glass, it is hard to form matte surface with various haze.

Therefore, in view of the drawbacks of the existing matte surface processing methods, the inventors develop this invention by the many-year manufacturing and design experience and knowledge in the related fields and ingenuity.

### SUMMARY

This invention is related to a method of forming anti-glare glass and products thereof. One aspect of this invention is to provide a method of forming a matte layer with anti-glare effect and various haze on a surface of a glass substrate and products thereof.

The method of forming anti-glare glass above comprises the following steps. A glass substrate is prepared, cleaned and then dried. Matte ink is sprayed on the glass substrate and then cured at a curing temperature in a heating device to form a matte layer on the glass substrate.

According to one embodiment, the method above further comprises the following steps. The glass substrate is heated on a heating plate to a setting temperature after the drying step, and the setting temperature is lower than the curing temperature. The glass substrate is heated at the setting temperature during the spraying step.

According to another embodiment, the setting temperature is 30-85° C. and the curing temperature is 200-350° C.

According to yet another embodiment, the matte ink comprises powder, a resin, a solvent and an additive.

According to yet another embodiment, a content of the powder is 0-10 wt %, a content of the resin is 10-30 wt %, a content of the solvent is 55-75 wt %, and a content of the additive is 0-5 wt %.

According to yet another embodiment, an average diameter of the powder is 20-200 nm.

According to yet another embodiment, a material of the powder is silicon oxide, aluminum oxide, titanium oxide, or any combinations thereof.

According to yet another embodiment, the resin is a silicone resin, an acrylic resin, an epoxy resin, an amino resin, a phenolic resin, an acetal resin, a fluorocarbon resin, an alkyd resin, or any combination thereof.

According to yet another embodiment, the solvent is an alcohol, an ether, an alcohol ether, a ketone, an ester, or any combinations thereof.

According to yet another embodiment, the additive is a leveling agent, a defoamer, a slip agent, a water repellent, an oil repellent, a thickener, or any combinations thereof.

According to yet another embodiment, the matte layer has a predetermined pattern having several areas with different haze.

According to yet another embodiment, the haze of the matte layer is gradually decreased from one side to the other side of the glass substrate.

A product made by the method above comprises a glass substrate and a matte layer having a predetermined pattern, and the the pattern has several areas with different haze.

Another product made by the method above comprises a glass substrate and a matte layer having a predetermined pattern, and the haze of the pattern is gradually decreased from one side to the other side of the glass substrate.

Accordingly, this invention uses an inkjet printer to precisely control the injection amount, patterns, and printing density to form the matte layer with anti-glare effect and with changing haze. Furthermore, the complicate process of attaching protective films can be omitted to increase the production efficiency. In addition, after forming the matte layer, the glass substrate still has high transparency without decrease the strength thereof to improve the use safety of matte glasses.

### BRIEF DESCRIPTION OF THE DRAWINGS

FIG. 1 is a process flow according to this invention.

FIG. 2 is a diagram showing a process flow according to this invention.

FIG. 3 is a three-dimensional view of an anti-glare glass formed by the method of this invention.

FIG. 4 is a three-dimensional view of another anti-glare glass formed by the method of this invention.

### DETAILED DESCRIPTION

To more completely and clearly illustrate the technical means and effects of this invention, the detailed descriptions are set forth below. Please refer to the disclosed figures and the reference numbers.

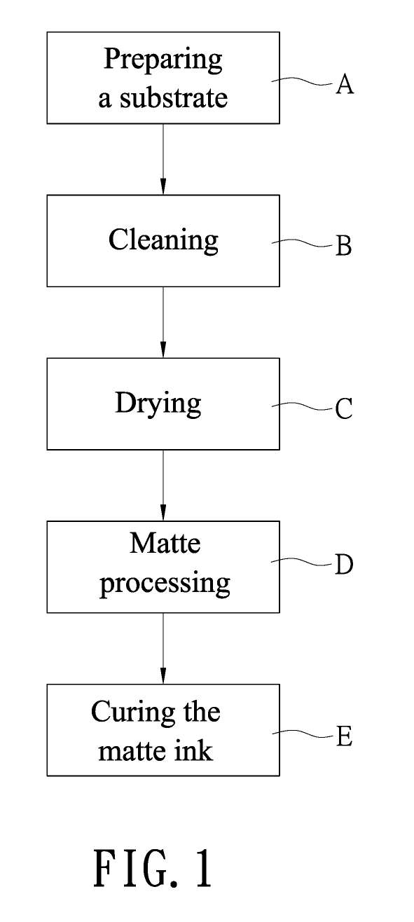

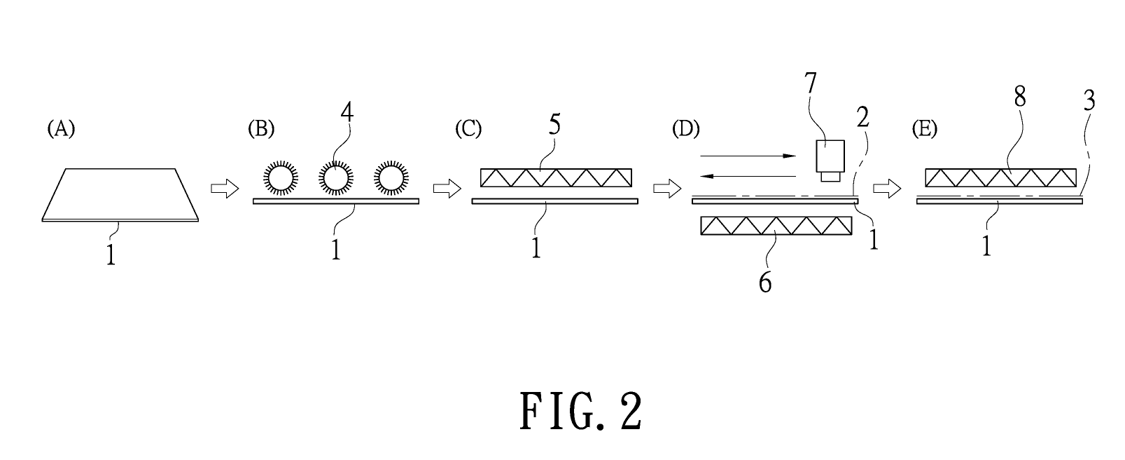

Please refer FIGS. 1 and 2, which are a method of forming an anti-glare glass according to this invention. This method comprises the following steps.

A. Preparing a substrate: A glass substrate 1 is prepared.

B. Cleaning: The glass substrate 1 is placed in an automated cleaning equipment, and grease on the surface of the glass substrate 1 is removed by rolling brush 4 with a degreasing agent or a detergent. Then, the surface of the glass substrate 1 is washed by pure water.

C. Drying: The cleaned glass substrate 1 is dried in a heating device 5, such as an oven, or naturally dried at room temperature.

D. Matte processing: The cleaned and dried glass substrate 1 is placed in a clean space. A heating plate 6 is placed under the glass substrate 1 to heat the glass substrate 1 to a setting temperature of 30-85° C. The temperature of the glass substrate 1 is maintained at 30-85° C. An inkjet printer 7 is used to jet matte ink 2 on the surface of the glass substrate 1. The matte ink 2 comprises 0-10 wt % powder, 10-30 wt % resin, 55-75 wt % solvent, and 0-5 wt % additive. The powder is silicon oxide, aluminum oxide, titanium oxide, or any combinations thereof. The average diameter (D50) of the powder is 20-200 nm. The resin is a silicone resin, an acrylic resin, an epoxy resin, an amino resin, a phenolic resin, an acetal resin, a fluorocarbon resin, an alkyd resin or any combinations thereof. The solvent is an alcohol, an ether, an alcohol ether, a ketone, an ester, or any combinations thereof. The additive is a leveling agent, a defoamer, a slip agent, a water repellent, an oil repellent, a thickener, or any combinations thereof. A layer of matte ink 2 is jetted on the surface of the glass substrate 1. At the same time, the heating plate 6 is used to maintain the temperature of the glass substrate 1 at 30-85° C. to accelerate the drying rate of the matte ink 2. Accordingly, the matte ink 2 is dried and set after contacting the surface of the glass substrate 1 at 30-85° C. In addition, when the content of powder of the matte ink 2 is 0%, the jetted matte ink 2 will be granular to achieve the matte effect.

E. Curing the matte ink: The glass substrate 1 having the matte ink 2 thereon is placed in a heating device 8, such as an oven, maintained at a temperature of 200-350° C. to evaporate the solvent of the matte ink 2. The matte ink 2 is cured at high temperature and then bonded on the surface of the glass substrate 1 to form a matte layer 3.

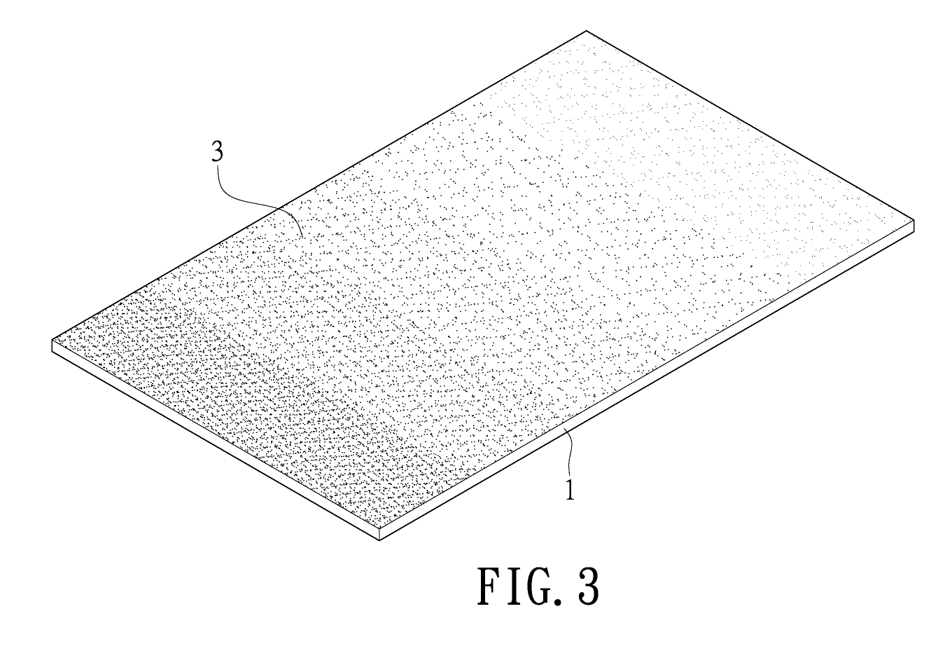

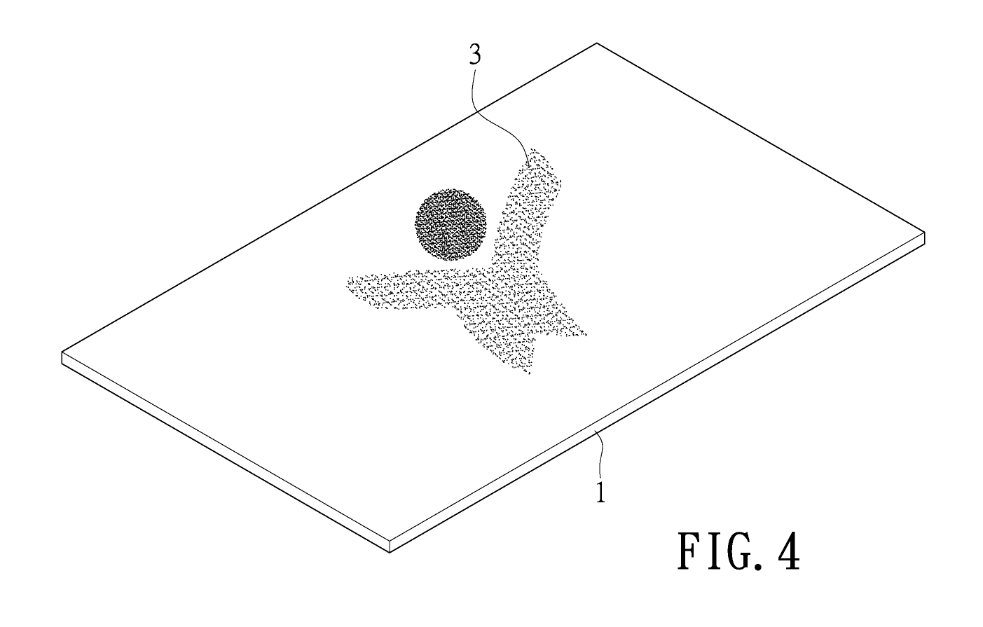

Accordingly, a matte glass product of a glass substrate 1 having a matte layer thereon can be conveniently produced by the method of forming anti-glare glass according to this invention. Since this invention uses an inkjet printer 7 to spray matte ink 2 on the surface of the glass substrate 1, the setting of spraying amount, formed patterns and spraying density of the matte ink 2 can be made on a computer linked to the inkjet printer 7. Therefore, the inkjet printer 7 can precisely spray matte ink 2 on the surface of the glass substrate 1 to form the needed pattern with the desired density. After drying and curing the matter ink 2, a matte layer 3 with haze decreased from one side to the other side of the glass substrate 1 gradually is formed, as shown FIG. 3, or a matte layer 3 with a predetermined pattern having several areas with various haze is formed, as shown in FIG. 4. In addition to decorative purposes, the matte layer 3 also make the light diffuse reflection, so that the light is soft and not harsh. The inkjet printer 7 can control the haze of the matte layer 3 to form products having anti-glare glass.

Furthermore, since the matte layer 3 is formed by the inkjet printer 7 spraying the matte ink 2 on the glass substrate 1, the amount, strength and range of spraying matte ink by the high-pressure air can be precisely controlled. Therefore, no protection film is needed to be attached on where does not need matte surface to omit the complicate processing procedure of chemical etching. The efficiency of producing matte glass is effectively improved. Moreover, this invention also can avoid the fragile problem caused by spraying emery to impact on the glass substrate 1 of the sandblasting and chemical etching. Hence, the quality, efficiency, and safety of producing the matte glass can be increased.

Please refer to Table 1, which is the test method and test results of various physical properties of the anti-glare glass made by the method according to this invention.

TABLE 1

| Test items | Test results |
|---|---|
| Pencil hardness, 750 g | >5H |
| 100 grid test | 5B |
| KOH (pH = 12), 50° C., 5 min | Δ Gloss ≤ 5 |
| 3% KOH, 12 hrs | Δ Gloss ≤ 10 |
| HCl (pH = 1), 8 hrs | Δ Gloss ≤ 5 |
| HNO₃ (pH = 1), 8 hrs | Δ Gloss ≤ 5 |
| Boiling water, 4 hrs | Δ Gloss ≤ 10 |

In Table 1, the load of 750 g was used to perform the pencil hardness test for the anti-glare glass of this invention. The matte layer 3 was scratched when the pencil hardness was greater than 5H. In the 100 grid test of the matte layer 3, the level of the matte layer was 5B, i.e. without any peeling off. The anti-glare glass was immersed in a KOH solution (pH=12) for 5 minutes at 50° C., and the gloss difference (Δ Gloss) of the matte layer 3 is 5 at most. The anti-glare glass was immersed in a 3% KOH solution for 12 hours, and the gloss difference (Δ Gloss) of the matte layer 3 is 10 at most. The anti-glare glass was immersed in a HCl solution (pH=1) for 8 hours, and the gloss difference (Δ Gloss) of the matte layer 3 is 5 at most. The anti-glare glass was immersed in a HNO₃ solution (pH=1) for 8 hours, and the gloss difference (Δ Gloss) of the matte layer 3 is 5 at most. The anti-glare glass was immersed in boiling water for boiling 4 hours, and the gloss difference (Δ Gloss) of the matte layer 3 is 10 at most.

Therefore, from Table 1, it can be seen that the gloss difference (Δ Gloss) of the matte layer 3 of the anti-glare glass is still between 5 to 10 after being immersed in strong acid, strong base, and boiled in boiling water for a period of time. That means, the haze of the matte layer 3 was not obviously changed in recession. The matte layer 3 is hard to be damaged by scratching, and immersing in acid and base. Hence, the matte layer 3 is very firmly attached on the glass substrate 1. The matte layer 3 of an anti-glare glass is resistant to chemical etching to facilitate the coatings of glass used in hand-held or consumer-related electronic products.

The embodiments or figures are not used to limit the forming method of the anti-glare glass and the product thereof in this invention. In this invention, the steps of heating the glass substrate 1 to the setting temperature, maintaining the glass substrate 1 at the setting temperature while the matte ink is sprayed on the glass substrate 1, and curing the matte ink 2 to form the matte layer 3 at a temperature of 200-350° C. The modifications and variations made by persons skilled in the art should be viewed as not departing from the scope of this invention.

From the structures and embodiments above, the invention has the advantages below:

1. In the method of producing anti-glare glass and products thereof, the inkjet process is used to form a matte layer on a glass substrate. Therefore, a computer linking the inkjet printer can be used to set the amount and density of the sprayed ink and the formed patterns. Therefore, a matte layer with anti-glare effect and various haze can be easily formed on glass substrates.

2. In the method of producing anti-glare glass and products thereof, the matte layer is formed on a glass substrate by using an inkjet printer. The amount, strength and range of spraying the matte ink can be precisely controlled. Therefore, the uniformity of the quality can be ensured. Moreover, the complicate process of attaching protective films can be omitted to increase the production efficiency.

3. In the method of producing anti-glare glass and products thereof, the matte layer is formed after spraying and curing the matte ink sprayed on the substrate by the inkjet printer. Therefore, the fragile problems of the glass substrates caused by impacting the glass substrate by emery and etching the glass substrate by a chemical agent. The use safety of matte glass can be improved.

What is claimed is:

1. A method of forming anti-glare glass, the method comprising:
preparing a glass substrate;
cleaning the glass substrate;
drying the glass substrate;
spraying a matte ink on the glass substrate;
curing the matte ink by placing the glass substrate in a heating device maintained at a curing temperature; and
forming a matte layer on the glass substrate.

2. The method of claim 1, further comprising:
heating the glass substrate on a heating plate to a setting temperature after the drying step, wherein the setting temperature is lower than the curing temperature; and
maintaining the glass substrate at the setting temperature during the spraying step.

3. The method of claim 2, wherein the setting temperature is 30-85° C. and the curing temperature is 200-350° C.

4. The method of claim 1, wherein the matte ink comprises powder, a resin, a solvent and an additive.

5. The method of claim 4, wherein a content of the powder is 0-10 wt %, a content of the resin is 10-30 wt %, a content of the solvent is 55-75 wt %, and a content of the additive is 0-5 wt %.

6. The method of claim 4, wherein an average diameter of the powder is 20-200 nm.

7. The method of claim 4, wherein a material of the powder is silicon oxide, aluminum oxide, titanium oxide, or any combinations thereof.

8. The method of claim 4, wherein the resin is a silicone resin, an acrylic resin, an epoxy resin, an amino resin, a phenolic resin, an acetal resin, a fluorocarbon resin, an alkyd resin, or any combination thereof.

9. The method of claim 4, wherein the solvent is an alcohol, an ether, an alcohol ether, a ketone, an ester, or any combinations thereof.

10. The method of claim 4, wherein the additive is a leveling agent, a defoamer, a slip agent, a water repellent, an oil repellent, a thickener, or any combinations thereof.

11. The method of claim 1, wherein the matte layer has a predetermined pattern having several areas with different haze.

12. The method of claim 1, wherein the haze of the matte layer is gradually decreased from one side to the other side of the glass substrate.

13. A product having an anti-glare glass, comprising:
a glass substrate; and
a matte layer having a predetermined pattern, wherein the pattern has several areas with different haze.

14. A product having an anti-glare glass, comprising:
a glass substrate; and
a matte layer having a predetermined pattern, wherein haze of the pattern is gradually decreased from one side to the other side of the glass substrate.
